(19) United States
(12) Patent Application Publication
(10) Pub. No.: US 2008/0135158 A1
(43) Pub. Date: Jun. 12, 2008

(54) Feeding Webs for Processing and Removing Webs

(75) Inventor: Peter Johan Baumli, New South Wales (AU)

Correspondence Address: KING & SCHICKLI, PLLC, 247 NORTH BROADWAY, LEXINGTON, KY, 40507, US

(73) Assignee: Impresstik Machinery Pty Ltd

(21) Appl. No.: 11/596,135

(22) PCT Filed: May 16, 2005
(86) PCT No.: PCT/AU05/00703

§ 371 Date: Aug. 22, 2007

(30) Foreign Application Priority Data
May 14, 2004 (AU) 2004902639

(51) Int. Cl. B31F 5/00; B65H 19/22; B29C 63/10; B32B 33/00

(52) U.S. Cl. 156/157; 156/504; 428/41.8; 156/187

(57) ABSTRACT

A splicing method and apparatus for use with a labelling apparatus is disclosed. Also disclosed is a method and apparatus for winding up and removing a web from a labelling apparatus, particularly the waste web from which self-adhesive labels have been removed by a labelling apparatus. Web splicing is achieved by detecting the end of one web feed and securing that end while it is transported to the start of another web feed to be adhered to that another web under a pressing action before being released to allow continuation of web feeding by the joined together webs.

### TECHNICAL FIELD

The present inventions relate to feeding a web of material and splicing a trailing edge of that web to a leading edge of a next web to facilitate continuing operation of a process downstream of the web feed as well as bundling and removing web material in successive bundles, such as following an upstream process carried out on the web. The inventive aspects will, for ease of explanation, be described in relation to feeding self-adhesive label containing webs to a labelling head as well as removing the waste web, exclusive of labels, from the labelling head. It will be appreciated that the specific description relative to labelling apparatus is not limiting upon the generality of the aspects of the present invention.

A purpose of preferred embodiments of the present inventions is to improve elements of self-adhesive label application while running self-adhesive labels continuously without having to stop for reel changes, in one aspect, or waste removal, in another aspect. Conventional systems are momentarily stopped for reel changes and waste removal and this causes considerable downtime when aggregated over time.

### BACKGROUND ART

What follows is a discussion of a typical example of a conventional system associated with a labelling machine with four labelling stations which operates on two shifts per day at a rate of 250 labelled items per minute.

According to figures provided by users of such arrangements some labelling machines may consume up to two twelve minute periods per hour for reel changes at the four labelling stations. This reflects a twenty percent downtime for fitting reels of new labels and for waste removal. If such an existing operation is averaged over a year having, say, two hundred and fifty working days with two eight hour shifts per working day then that equates to a loss of twenty shifts per year directly attributed to reel changes or, putting it another way, 2.4 million items of lost throughput per year.

The waste web or backing release paper upon which self-adhesive labels are mounted is generated as each label is peeled off that backing paper. That waste web must be removed out of the indexing or continuous motion drive system of a labeler once a predetermined size of waste has been reached. For this reason a waste removal device which automatically removes the waste into a bin has been used. Conventional systems remove the waste from the labelling machine area via a human operator which generally requires the machine to be stopped when the operator is carrying out that task.

When the end of a label-feeding reel is reached the machine is generally stopped to allow transfer to another full feeding reel. There exist automatic and semi-automatic splicing facilities which are in use but they differ in their mode of operation from that aspect of the present invention.

A splicing device for the present invention functions to join the end of a label carrying web of an exhausted reel to the beginning of the web of the next full reel while the label applying station continues to run at its normal operating speed in registration with, say, a label die cutting edge. How this is able to be effected is disclosed below.

By integration of the independent inventive aspects disclosed herein it is possible to provide a method and means for feeding a web of self-adhesive labels to a label applying station and for removal of the waste web material so as to ameliorate existing difficulties associated with feeding a web of self-adhesive labels and with removing the waste web.

With regard to feeding a web which holds self-adhesive labels to a labelling head and thereafter removing the waste web, it is usual to operate as a reel-to-reel arrangement with the label applying head therebetween.

Problems arise in maintaining a continuous feed of labels to the label applying head while changing over from an exhausted label supplying reel to a full reel and making a satisfactory splice between the end of the label supporting web, from the exhausted reel, and the beginning of the web from the full reel.

There are also problems in effectively removing the waste web material from the reel downstream of the label applying head, when that downstream reel is full.

The reference to any prior art in this specification is not, and should not be taken as, an acknowledgment or any form of suggestion that the prior art forms part of the common general knowledge in Australia.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

A typical prior art arrangement employs two separate label supplying reels feeding respective label applying heads at a label applying station. When one reel feeding its labels to its label applying head is exhausted the other reel commences feeding its associated label applying head. This mode of operating supply reels and label applying heads enables an exhausted reel to be replaced during operation of the other unwinding reel. Such an arrangement is difficult to manage so that there is a smooth transition from one label applying head to the other while maintaining label applying accuracy during that transition. It also entails the use of an additional label applying head.

### DISCLOSURE OF INVENTIONS

In the broadest form of a first aspect of the present invention there is provided a method of splicing a trailing edge of a first web to a leading edge of a second web, said method including having two web supplying stations, one web supply feeding one splicing station and another web supply feeding another splicing station; and drawing one web from its supply while a leading edge of the other web is positioned at the other splicing station ready to be spliced to a trailing edge of the one web; detecting and holding the trailing edge of the one web, moving said trailing edge to the other splicing station and splicing the trailing edge of the one web to the leading edge of the other web and drawing off the other web from the other web supplying station.

Preferably, each web supplying station is a reel.

In another embodiment a sufficient supply of one web is provided downstream of the one web splicing station to meet a demand for supply of web material during holding and splicing of the trailing edge of the one web to the leading edge of the other web preparatory to drawing off the other web. Preferably, the sufficient supply of one web is facilitated by at least one loop control.

In a particularly preferred embodiment the first and second webs are carrying self-adhesive labels to be fed to a labelling head

In a second aspect the present invention provides a method of forming and removing a roll of web material from a rotatable device, said method comprising loading a quantity of web material onto the rotatable device, clamping and cutting the web being wound onto the rotatable device when a predetermined quantity of web material has been wound onto the rotatable device, pushing the wound web off the rotatable device, re-attaching the cut end of the web to the rotatable device and winding a next quantity of web onto the rotatable device.

A preferred form of the second aspect includes a loop control in the path of web material upstream of the clamping and cutting location. The provision of loop control of the web material enables the web material to be cut and removed from the rotatable device while an upstream process, such as the operation of a labelling head, continues and provides web material which is temporarily stored in the loop by operation of the loop control.

Preferably, the second aspect of the invention is employed in forming a roll of waste web material from a labelling machine and pushing the roll from the rotatable device.

In a third aspect the present invention provides a splicing tape for use in a splicing method and apparatus of the present invention or for use in other applications separate from a splicing method of the present invention. This splicing tape is formed as a reel of adhesive tape where the adhesive surface is fitted with release paper separable longitudinally of the tape.

In a fourth aspect the present invention provides a method and means for affixing a web of material to a hub of an unwinding reel, said method comprising applying a double-sided adhesive tape to the hub of the reel, said tape having adhesives of differing strengths on opposite sides and wherein the side with the higher adhesive strength is applied to the hub, the adhesive side of the tape facing outwardly of the hub is adapted to grip and hold the end of a web wound onto the hub such that upon unwinding of the web, the end of the web separates from the adhesive tape and the adhesive tape remains adhered to the hub.

### BRIEF DESCRIPTION OF DRAWINGS

Embodiments of the present inventions will now be described by way of example with reference to the accompanying drawings, in which:—

FIG. 1 is a front elevation view of a first embodiment of an adhesive label web unwinding and waste web winding-up assemblies incorporating embodiments of each inventive aspect included in this specification, apart from an embodiment of a form of web end and/or web start adapted to ease splicing as shown by FIGS. 5 and 6;

FIG. 2 is a magnified view of the major functional elements of FIG. 1;

FIGS. 3a and 3b are front elevation views showing alternate positions for the splicing head depending upon whether a label web is being fed from one unwind reel or the other;

FIG. 4 shows two plan views and a front elevation view of the waste web take-up reel or splicing arrangement as shown in FIG. 1;

FIG. 5a is an isometric view of a reel of adhesive tape suited for use as a splicing tape in association with an adhesive label supporting web;

FIG. 5b is an end elevation view of the tape of FIG. 5a;

FIG. 5c is an end elevation of a second embodiment of a tape of the kind of FIGS. 5a and 5b;

FIG. 6 shows side elevation and plan views of a web supporting successive self-adhesive labels and incorporating an adhesive portion of the tape of FIG. 5;

FIG. 7 shows a preferred web mounting arrangement on the hub of a reel in accordance with an embodiment of the fourth aspect of the present invention;

FIG. 8a is a front elevation of a second embodiment of an adhesive label web-unwinding and waste web winding-up assemblies incorporating embodiments of aspects of the present invention;

FIG. 8b is a close-up view of the second embodiment of FIG. 8a;

FIG. 9 is a front elevation view of a waste web take-up station as shown in FIGS. 1, 2, 8a and 8b;

FIGS. 10a and 10b are front elevation views showing alternate positions for the splicing head of FIGS. 8a and 8b depending upon whether a label web is being fed from one unwind reel or the other;

FIGS. 11a and 11b are magnified views of the splicing station of FIGS. 10a and 10b, respectively, detailing the splicing operation that takes place between two webs as a transition occurs from the feeding of the end of one web and the start of another web;

FIGS. 12a and 12b show an alternate arrangement to that of FIG. 9 for loading a web wind up spindle; and

FIG. 12c is an isometric view of a modified portion of web material.

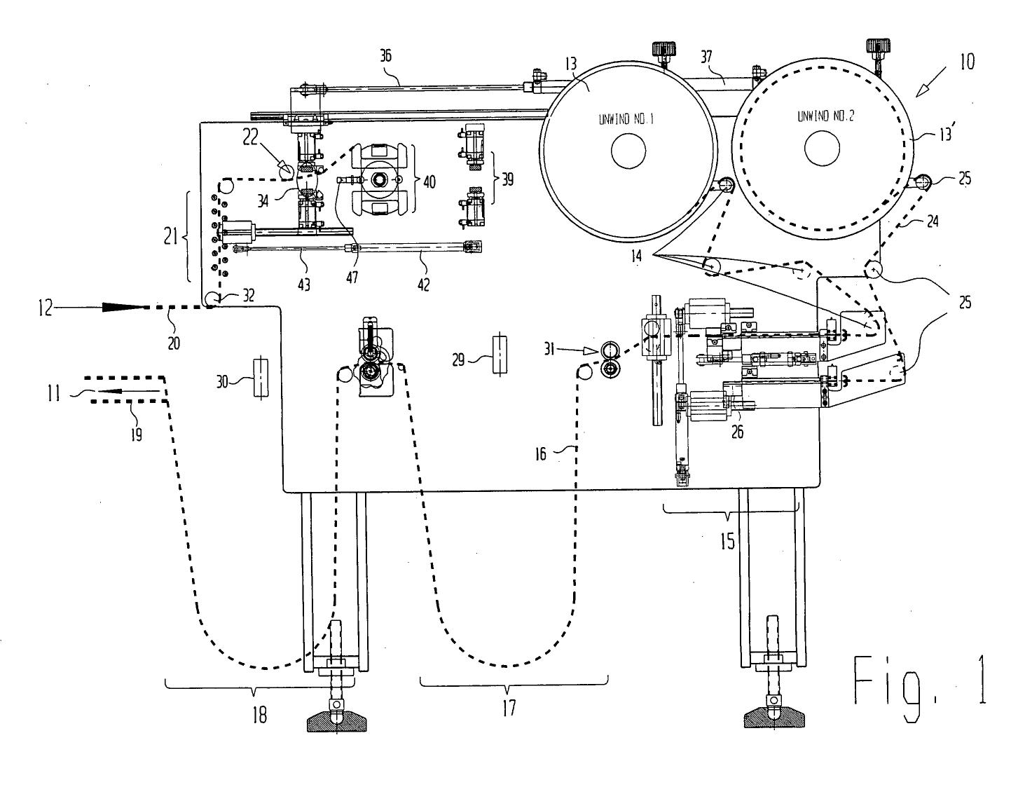

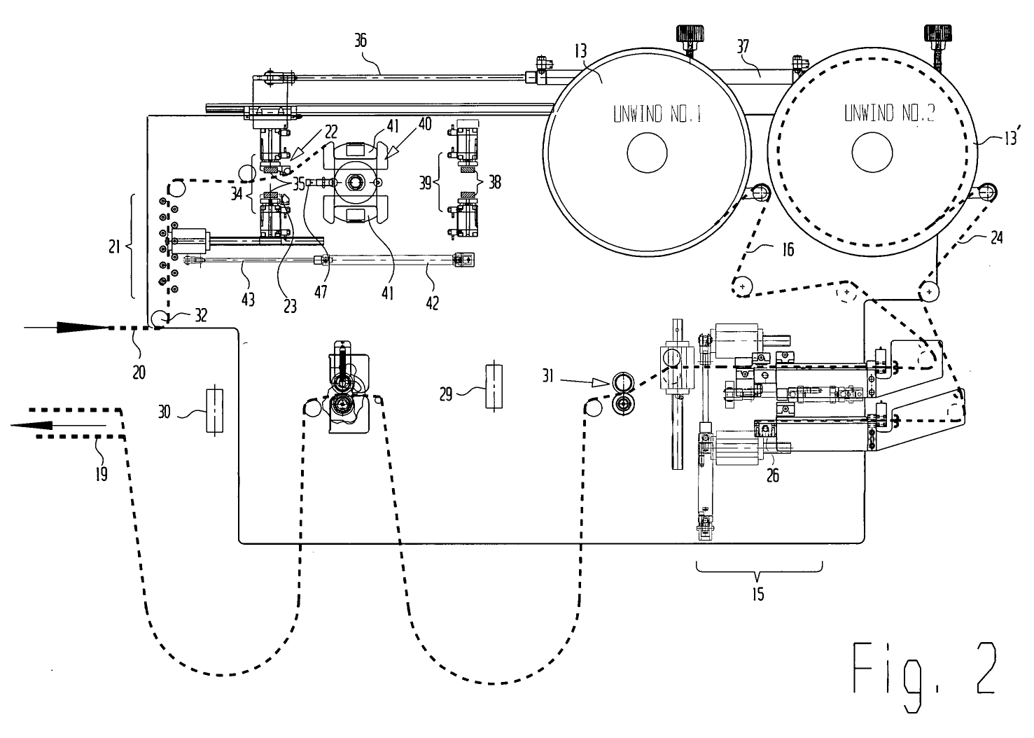

FIGS. 1 and 2 show an apparatus 10 which is adapted to feed a self-adhesive label applying web to a label applying head (not shown) located at position 11 and to collect the waste web from that label applying head which is fed to apparatus 10 from position 12.

At the commencement of operation an operator feeds a label web from one of the loaded unwind reels 13 and 13′. As shown in FIGS. 1 and 2 unwind reel 13 is tracked through rollers 14 before passing through interchangeable splicing zone 15. After leaving zone 15 the label web 16 passes through a first loop control zone 17 then into a second loop control zone 18 before entering a web turning bar 19 which leads to a labelling head (not shown). Suitable labelling heads for use with the present invention are well known in the art and will not be described herein. The present embodiment is concerned with the feeding of a label supporting web to and removal of the waste web from any desired form of label applying head adapted to fix self-adhesive labels releasably supported on a backing sheet or web of release paper.

Waste web 20, being web 16 with the self adhesive labels removed, enters loop control zone 21 before passing clamping and cutting station 22 then on to be wound to waste take-up reel or spindle 40.

It will be appreciated that there are substantial safety issues relating to operation of machinery of the type shown in the drawings. In particular, access to various sections of the equipment will result in pausing the motion of moving parts so as to allow an operator to carry out appropriate operations in a safe manner. Detailed discussion of those safety aspects will not be provided here, as they do not form an essential inventive aspect of the various embodiments of the inventions, as such, which are disclosed herein.

### Splicing

Operation of the apparatus 10 as shown in FIG. 1 is ready to commence with feeding of labels from reel 13 to a label applying station (not shown). At this time reel 13′ is in a full condition with its label containing web 24 passing around rollers 25 and stopping at a splicing position on table 26 to be held there by a vacuum head ready to be spliced to the trailing end of web 16 when reel 13 is exhausted.

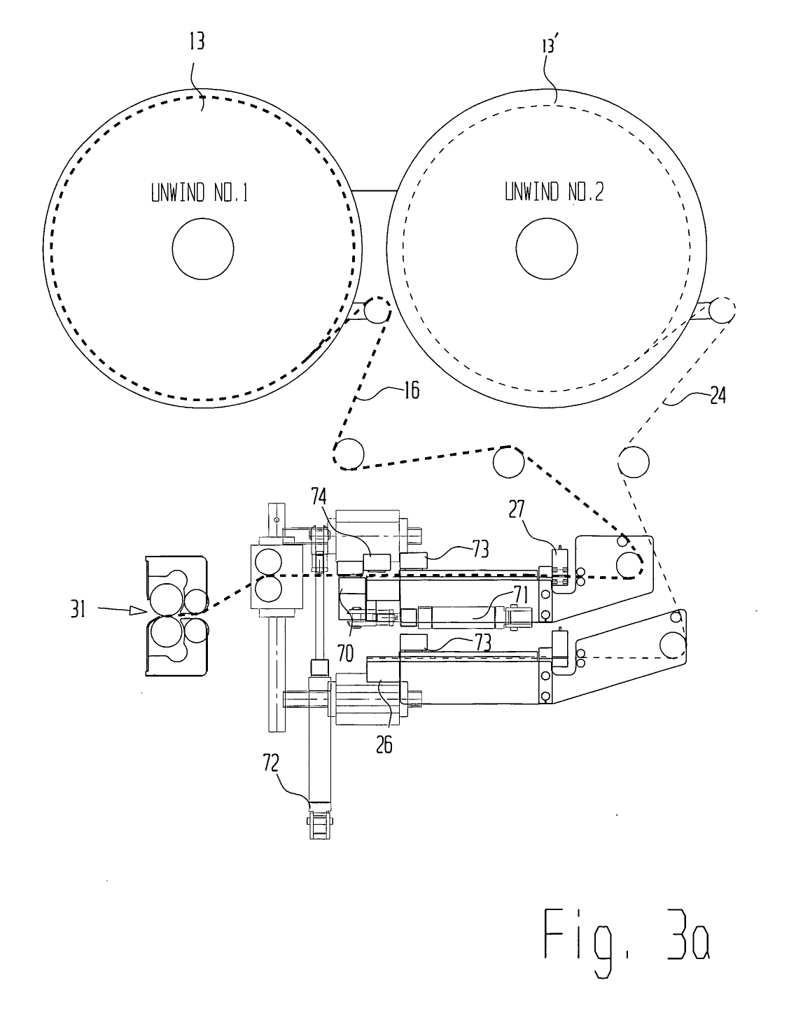

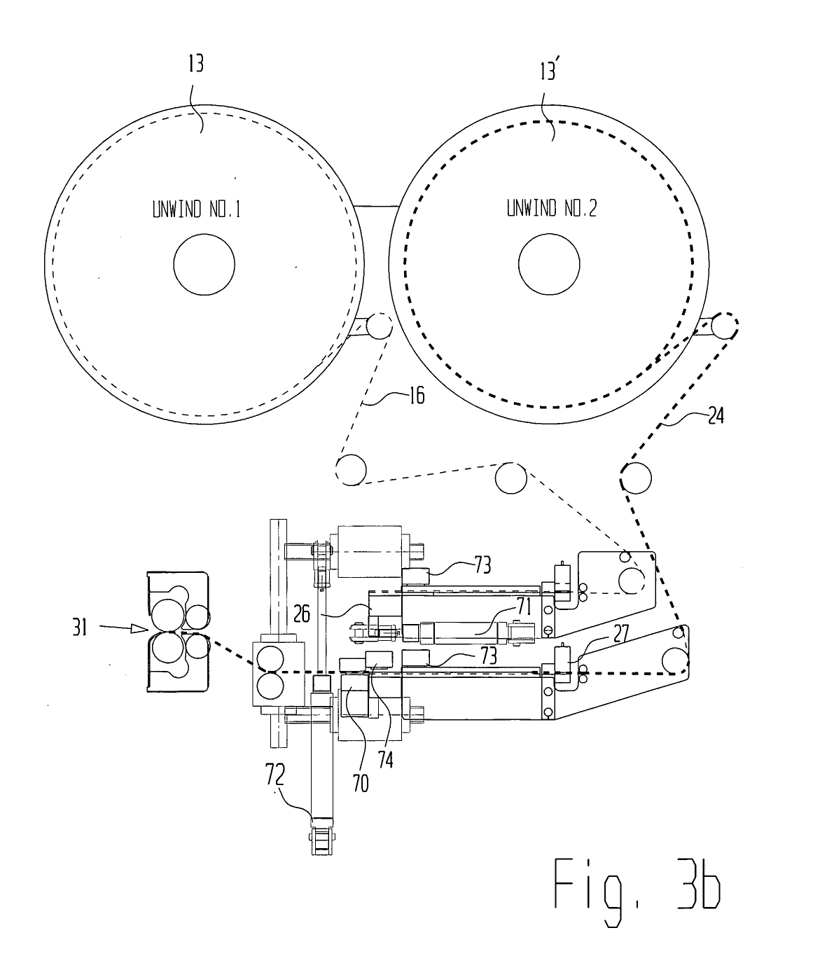

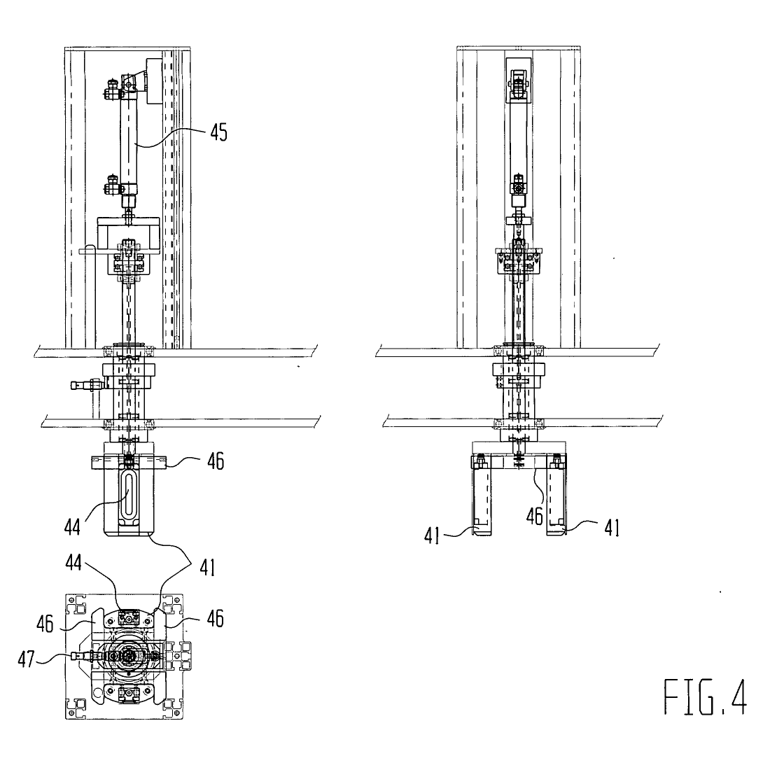

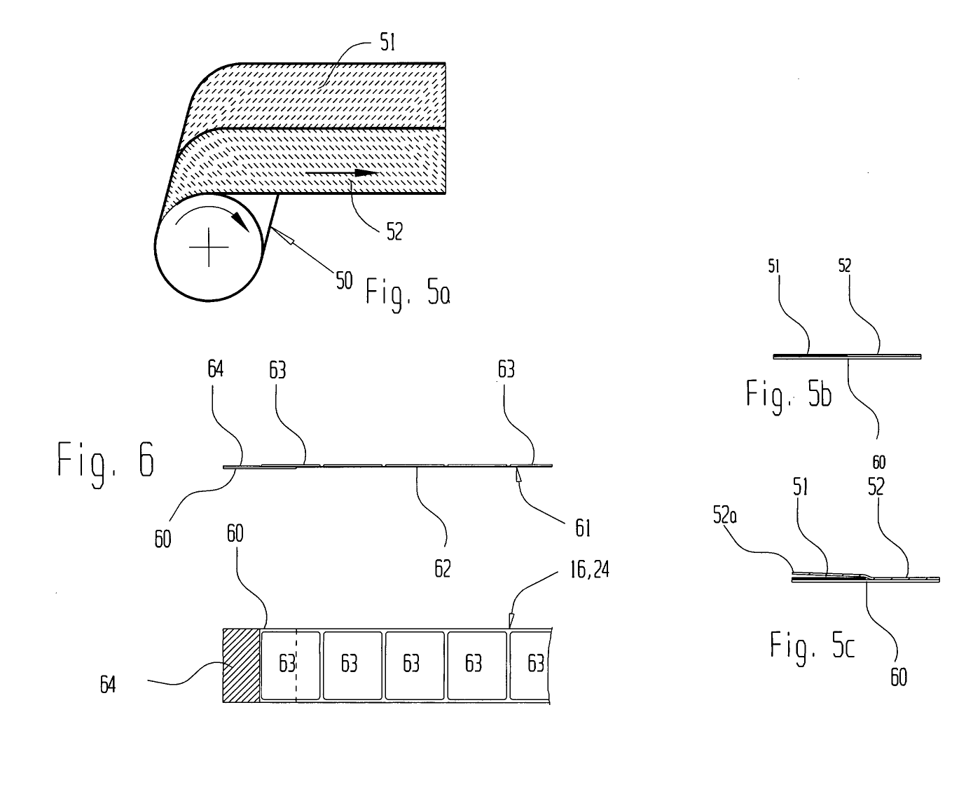

The operation of the splicing head is more clearly depicted in FIG. 3. FIG. 3a displays feeding from reel 13 while FIG. 3b displays feeding from reel 13′. The transition from reel 13 to reel 13′ is effected as follows:

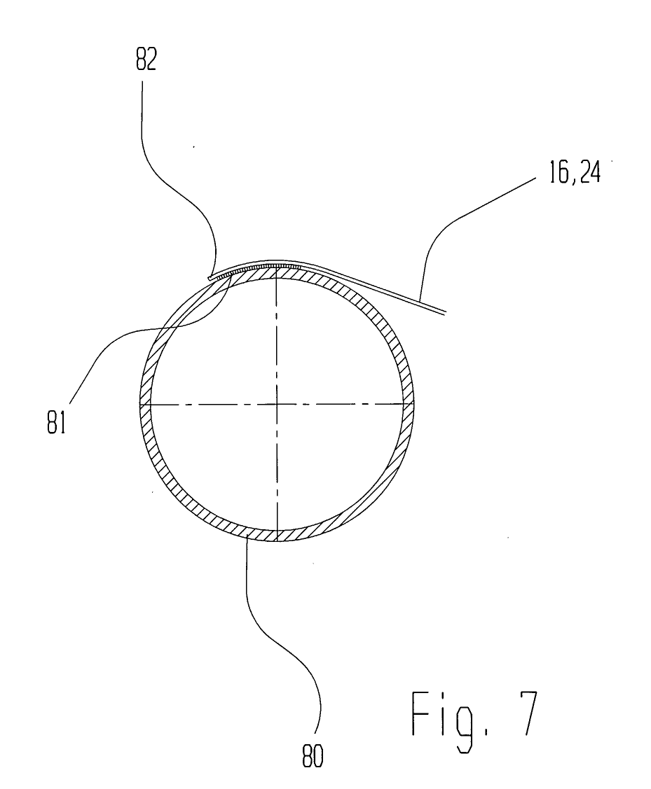

To initiate a splice between the end of web 16 and the beginning of web 24, an end of web 16 is detected by a scanner 27 which activates web clamp 70 ready to execute a splice between the end of web 16 and the beginning of web 24. This occurs in conjunction with controlling a loop control motor for the first loop in zone 17 whereupon web clamp 70 and bladder clamp 74 on a carriage moves downwardly as shown between FIGS. 3a and 3b to affix the end of web 16 to a leading portion of web 24 at the lowermost splicing position. The preferred form of splicing tape and its function is shown in FIGS. 5 and 6 and will be described later.

In more detail, a splice is executed in the following manner:

To initiate a splice the reel in use (13 or 13′) must see an end of web (16 or 24) condition on scanner 27. Once the end of web (16 or 24) is sensed, the end of web is positioned and clamped by clamping cylinder 70 ready to execute a splice. This positioning movement is made by loop control drive 31.

Once the end of web is gripped in the correct location by clamping cylinder 70, the horizontal cylinder 71 extends to displace the carriage supporting the end of web, clamp 70 and clamp 74 and thereafter the vertical cylinder 72 changes location. The horizontal cylinder 71 retracts the carriage to the position for the splice to be made. A splice effected by extending splice bladder clamp 74 toward table 26 with webs 16 and 24 therebetween and removing web bladder clamp 73. After clamp 74 is released the newly spliced web (16 to 24 or 24 to 16) is ready to be run to the labelling head (not shown) once clamping cylinder 70 is also released.

During the splicing of web 16 to web 24 the label applying head consumes labels on web material looped in zones 17 and 18. If both loops become exhausted before a splice is made the label applicator is controlled to shut down. Control of the size loops in each of zones 17 and 18 is achieved by control signals provided by respective sensors 29,30. In this embodiment sensors 29,30 are ultrasonic devices that measure the distance between each sensor and its associated loop of label web 16.

Once a splice is successfully made, web clamp 73 is released to allow feeding of web material 24 as shown in FIG. 3b with loop control drive 31 being reactivated to draw web 24 off reel 13′.

Preferably control of the above-described splicing operation is automatically achieved by means of air cylinder or motor movements. Once emptied reel 13 stops operating and feed of a new web 24 from reel 13′ is under way, reel 13 can be replaced by a fully loaded reel and readied to be in the position shown by FIG. 3b. As the splicing operation happens without operator intervention it is only necessary for the operator to put replacement reels in position as and when they empty following a splicing change over to the full reel of the pair 13, 13′. Desirably, the design of the equipment is such that the fitting of a replacement reel in no way interferes with web feeding from the unwinding reel so that label applying continues while each replacement reel is fitted.

It will be appreciated that while two loops of web material 16 or 24 are shown in zones 17 and 18 of this embodiment, the number of loops that are required are up to the designer and very much depend upon the rate of feed of labels to a label applying head as compared with the time taken to effect a splice between webs 16 and 24 or 24 and 16, as the case may be.

### Waste Removal

The operation of the embodiment of an automatic waste removal system of another aspect the present invention as shown in the drawings is as follows:

In FIGS. 1 and 2 waste backing paper web 20 exits a labelling head (not shown) along pathway 12 and around turning bar 32 before passing through loop control zone 21 and on through waste loading clamp 34. Web 20 is manually pulled through open jaws 35 of clamp 34 then through the gap between fork arms 41 of waste spindle 40 and on to be gripped by jaws 38 of clamp 39 upon a first loading. The correct positioning of fork arms 41 to allow feeding of web 20 therebetween is controlled by position sensor 47. For subsequent automatic reloading of spindle 40 the clamp 34, with jaws 35 gripping web 20 is moved via strut 36 in air cylinder 37 so that web 20 is between jaws 38 of start-up clamp 39. Clamp 34 is forward mounted of waste spindle 40 while clamp 39 is mounted rearwardly of spindle 40.

Jaws 35 are in the form of forks or arms that project in the direction of into the page of drawing FIGS. 1 and 2. Jaws 38 of clamp 39 are in the form of forks or arms that project in the direction of out of the page of drawing FIGS. 1 and 2. Jaws 35 are sized, when clamped together, to pass horizontally between arms or forks 41 of waste spindle 40, when oriented as shown in FIGS. 1 and 2, and also between open jaws 38.

After jaws 35 holding web 20 have traveled through forks 41 and open jaws 38, the latter are clamped together to hold web 20 while jaws 38 are retracted to release web 20 and allow open clamp 34 to be returned to its position as shown in FIGS. 1 and 2.

Spindle 40 is then activated to wind-up web 20 to form a reel of waste release paper with its winding-up rate being controlled in harmony with the rate of consumption of labels by the labelling head (not shown).

When the reel of waste web 20 on spindle 40 reaches a predetermined size for ejection from spindle 40, clamp 34 is operated to clamp and cut web 20. Clamp 34 includes a cutting knife 23 which cuts web 20 as jaws 35 come together to clamp web 20. As the labelling head is still operating and producing waste web material 20 during clamping cutting and ejection, the waste web loop control 21 operates to take up the web material 20 which is output during the ejection of the reel of material 20 off spindle 40. Air cylinder 42 moves its strut 43 to the right as shown in FIGS. 1 and 2, which in turn draws the left hand column roller set of loop control 21 to the right so as to increase the distance of travel for the web material 20 as it passes between the left and right hand columns of rollers of loop control 21.

Once cutting knife 23 cuts the waste web material, the rotational speed of spindle 40 is slowed, air operated waste spindle expansion cylinders 44 retract and waste ejection cylinder 45 is activated to drive waste ejector 46 against the reel of waste material and push that reel along and off fork arms 41.

After each reel of waste material has been ejected off fork arms 41 the waste spindle is stopped in its homed position as shown in FIGS. 1 and 2, thereafter spindle 40 is re-loaded by movement of web 20, clamped between jaws 35 of clamp 34 travelling between fork arms 41 of spindle 40 then through open jaws 38 of clamp 39 and so on as discussed above in relation to a first loading, thereby completing a cycle of the waste removal operation of the depicted embodiment.

### Splicing Tape

FIG. 5a shows a roll 50 of single-sided adhesive tape with the adhesive surface being outermost and covered by separate portions of release paper 51, 52.

The manner of use of the adhesive tape of the embodiment of FIG. 5 as a splicing element in an embodiment of the present invention is shown in FIG. 6. A portion 60 of the tape of FIG. 5 is separated from roll 50. One of release papers 51 and 52 is removed and the exposed adhesive surface is adhered to the underside 61 of label backing paper 62 supporting labels 63. The release paper portion 64 remains in place until the underlying adhesive is to be exposed to adhere to another label backing paper and splice two label webs (16, 24) together.

The embodiment of FIG. 5c is of a tape with a first removable release paper 52 having an extension reaching across and above release paper 51. This arrangement makes it easier to remove release paper 52 than is the case with the embodiment of FIGS. 5a and 5b.

### Unwinding Hub

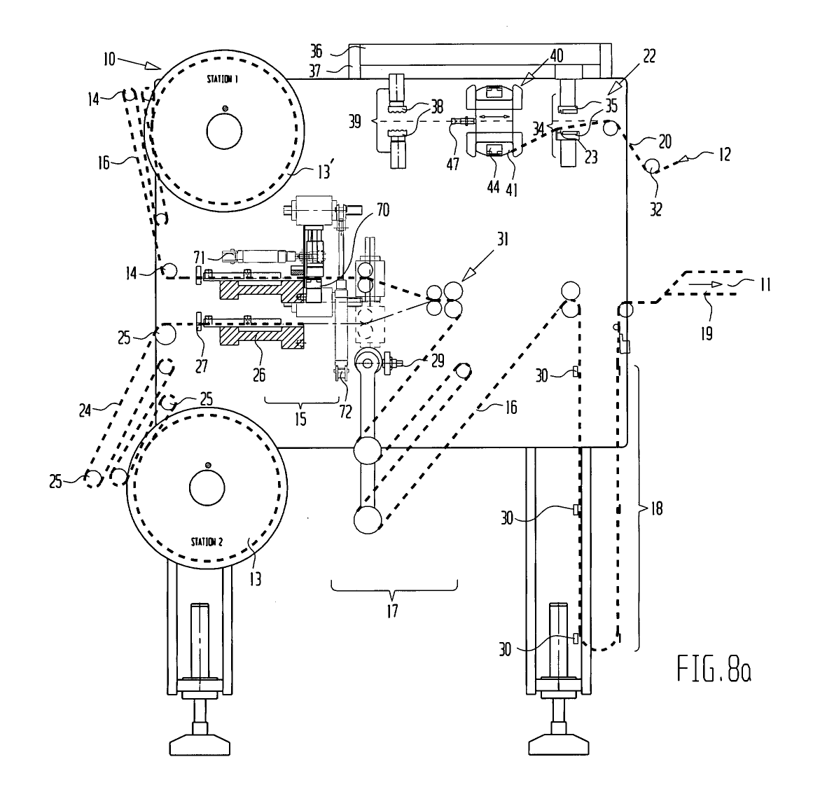

FIG. 7. Shows an embodiment of a mode of affixing a label supporting web to the hub of an unwinding reel (13 or 13′). In FIG. 7 hub 80 has a portion of double-sided adhesive tape 81 thereon. The stickability of the adhesive on each side of the tape differs with the tape 81 adhering to the hub more strongly than the label carrying web 16 or 24 adheres to the tape 81. In addition, the web 16, 24 is adapted to release from tape 81 at the complete unwinding of web 16, 24 from reel 13, 13′. This clean release from tape 81 leaves a sharply defined end 82 on web 16 or 24 which provides a reliable end of web trigger for activation of a splicing method in accordance with the invention herein or otherwise described. The clean release of a label carrying web from the hub of a reel (13 or 13′) facilitates use of the last label on that web by a labelling head irrespective of splicing that web with another web or not. This contrasts with existing systems which suffer problems in achieving a clean release from a hub so as to allow use of a last label on a reel of label supporting web material.

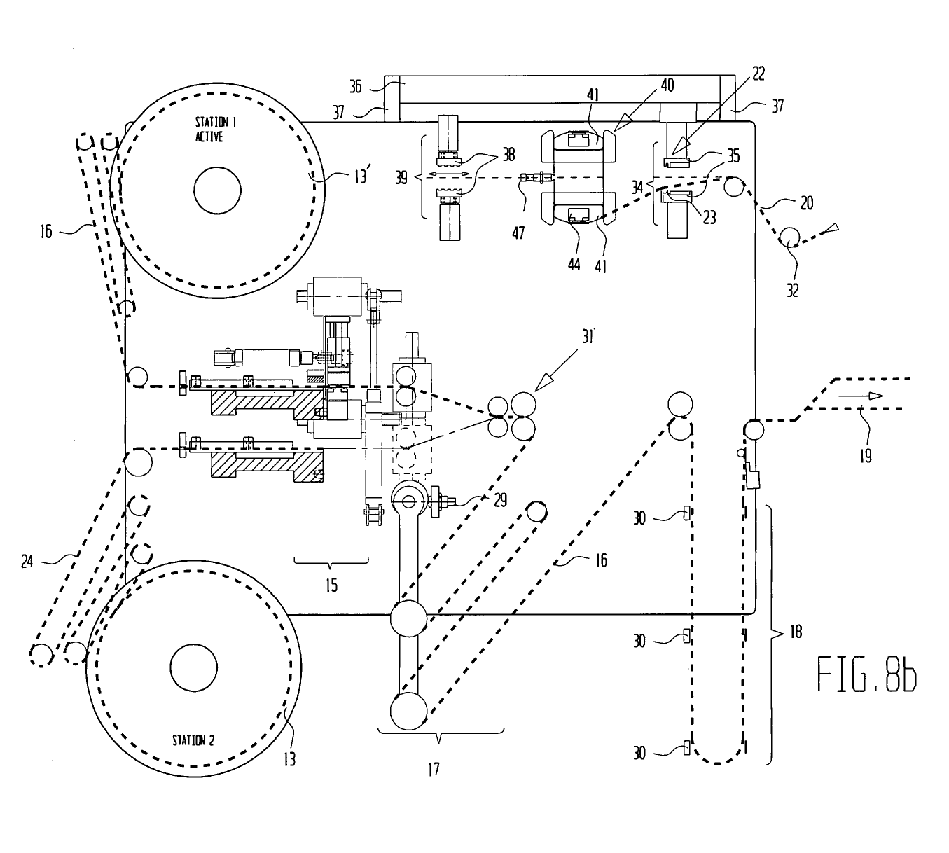

The embodiments shown in FIGS. 8a and 8b have corresponding reference numerals applied to the same or like elements as depicted in drawing FIGS. 1-4.

In FIG. 8 control loop 17 has been varied from the form shown in FIGS. 1 and 2 and is now comprised of a pendulum arm, having its movement detected by sensor 29, acting as a buffer for the web as splicing is carried out in zone 15 while the labelling head (not shown) continues to operate. This buffer 17 is required to provide a reserve supply of label supporting web during the time that splicing occurs. Should proximity switches 30 not detect web within zone 18 the apparatus is designed to stop and manual splicing will be required before continuing.

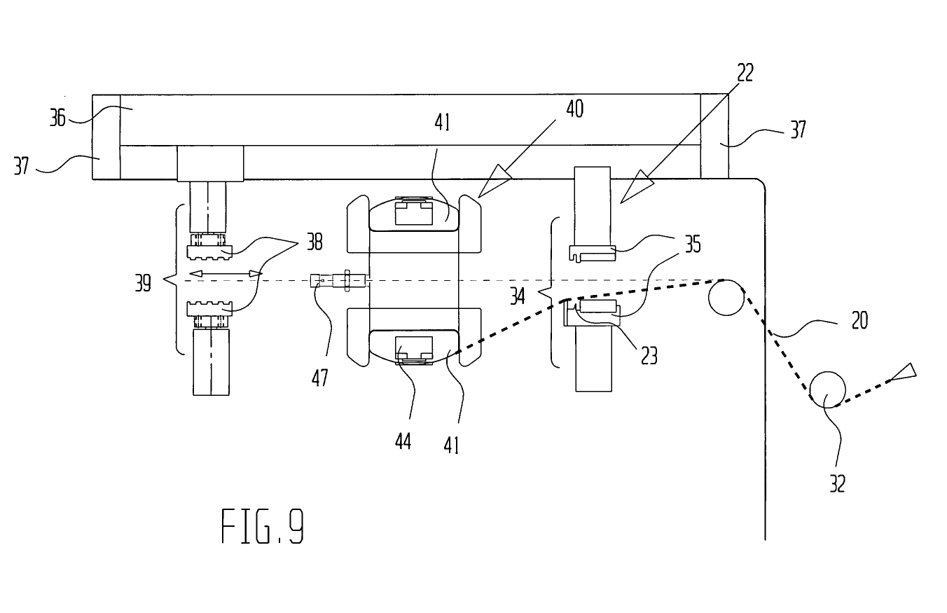

For initial loading of spindle 40 of FIG. 9 it is not necessary to clamp web 20 in jaws 38 but only in jaws 35 for loading through fork arms in an arrangement where a web buffer is provided upstream of jaws 35. Clamp 34 is movable back and forth along track 36 mounted on arms 37.

In an alternative mode, the sequence for reloading of spindle 40 is reversed where clamp 39 functions to be the web moving clamp and clamp 34 with knife 23 at cutting station 22 is fixed. In this version the initial loading of web 20 is held by jaws 35 of clamp 34. Clamp 39 with jaws 38 open are moved to the upstream side of side of clamp 34 and then jaws 38 clamp web 20. Clamp 34 is then opened and jaws 38 gripping web 20 passes through forks 41 and the winding up is commenced.

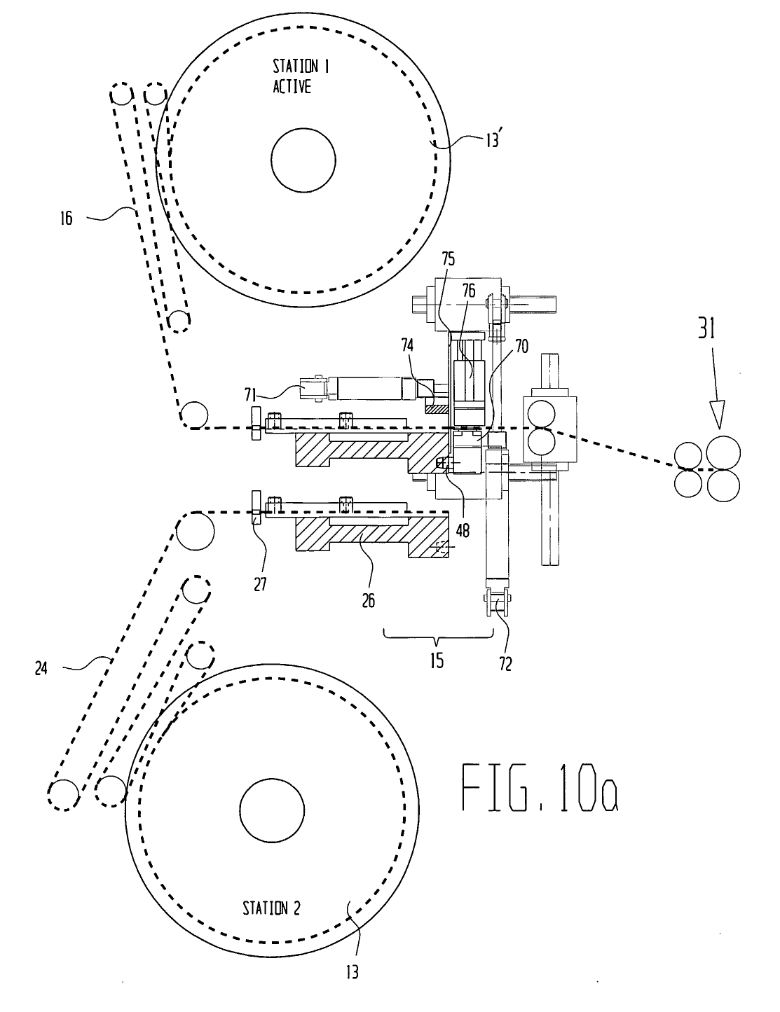

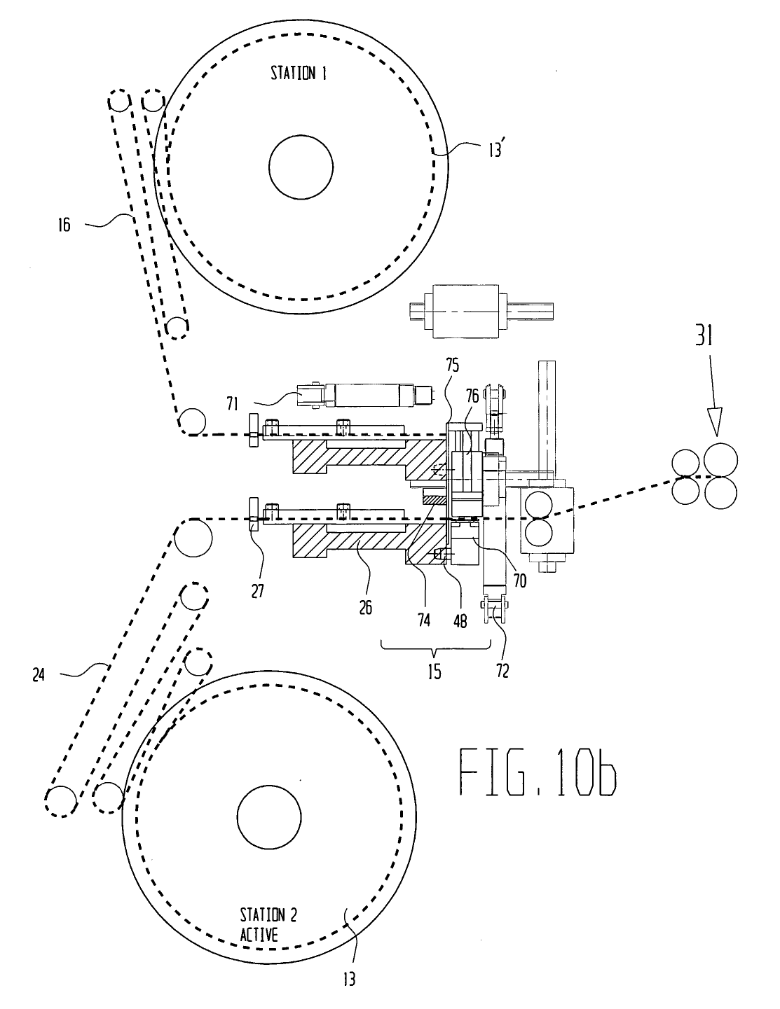

FIGS. 10a and 10b are equivalent to the arrangements shown in FIGS. 3a and 3b, respectively. In this embodiment, however, a locating pin 48 secures the carriage supporting the bladder clamp 70 at each splicing and web feeding position relative to respective splicing tables 26.

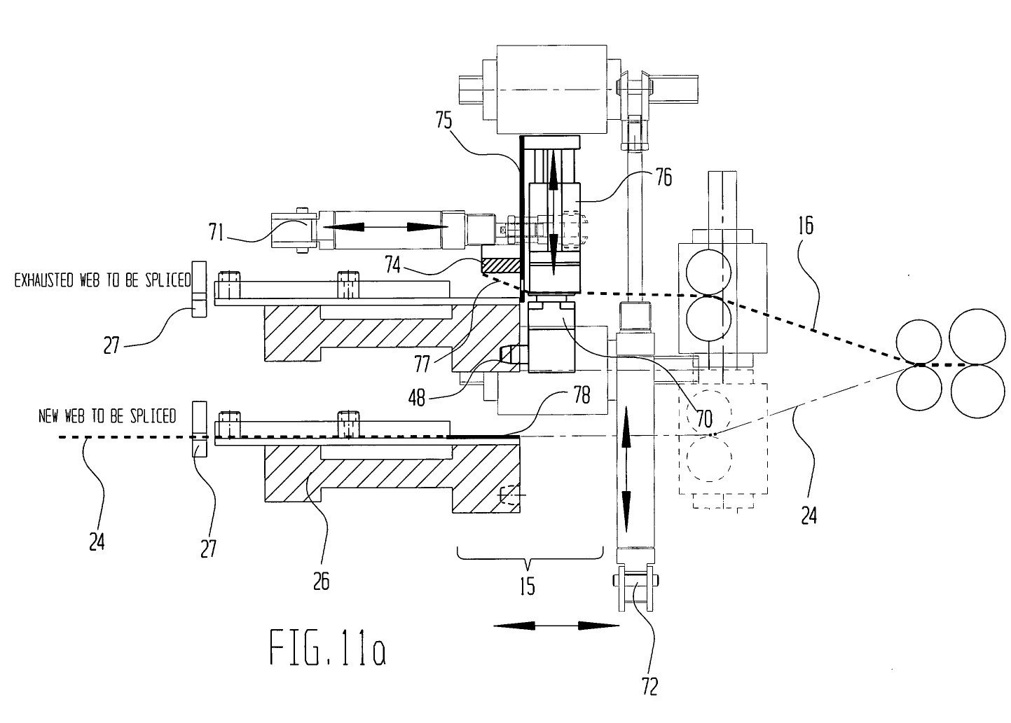

In this embodiment the carriage, comprising splice bladder clamp 70, vacuum head 74 coupled to mounting arm 75, position cylinder 76 and locating pin 48, is movable between the positions shown in FIGS. 10a and 10b and also in FIGS. 11a and 11b under the operation of air cylinders 71 and 72.

Referring to FIGS. 10a, 11a the end of web 16 is detected by sensor 27. That detection initiates the splicing operation. Prior to the end of web 16 reaching its position to be clamped ready for splicing with the leading edge of web 24, position cylinder 76 extends downwardly to create tension in web 16. Once the trailing end of web 16 has reached its desired final position it is clamped by the action of web clamp 70 moving to grip web 16. Thereafter position cylinder 76 is retracted, the trailing edge of web 16 is raised by vacuum and clamping head 74 via movement of mounting arm 75 to the position as is shown in FIG. 11a. Cylinder 71 then moves the carriage to the right, as shown in FIG. 11a, so that pin 48 becomes disengaged from the uppermost splicing table.

Cylinder 72 is then activated to move the carriage down to the position shown in FIG. 11b; cylinder 71 then moves the carriage to the left so that it locks with lowermost splicing table 26 as pin 48 engages with the complementary recess in that table as shown in FIG. 11b.

Vacuum head 74 with the trailing edge of web 16 attached is lowered on mounting arm 75 so that the underside of the trailing end of web 16 is brought into contact with adhesive surface 78 at the leading end of web 24.

Once adhesive contact has been made between webs 16 and 24 the splice is complete and vacuum and clamping head 74 is released so that the last of web 16 with the front of web 24 attached is then allowed to continue feeding web to a desired station.

To go from the position of FIG. 11b to that of FIG. 11a, the above described splicing steps are reversed.

By having sufficient web material with a variable length feeding loop or loops 17, 18 it is possible to maintain continuity of web delivery to a downstream station while the splicing operation is being effected.

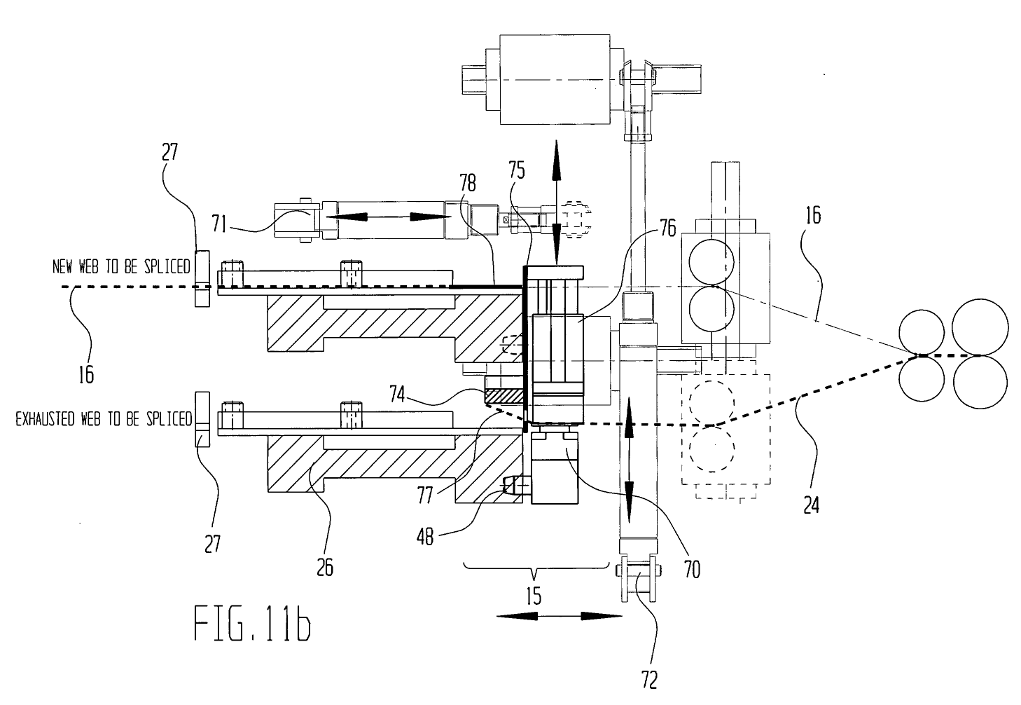

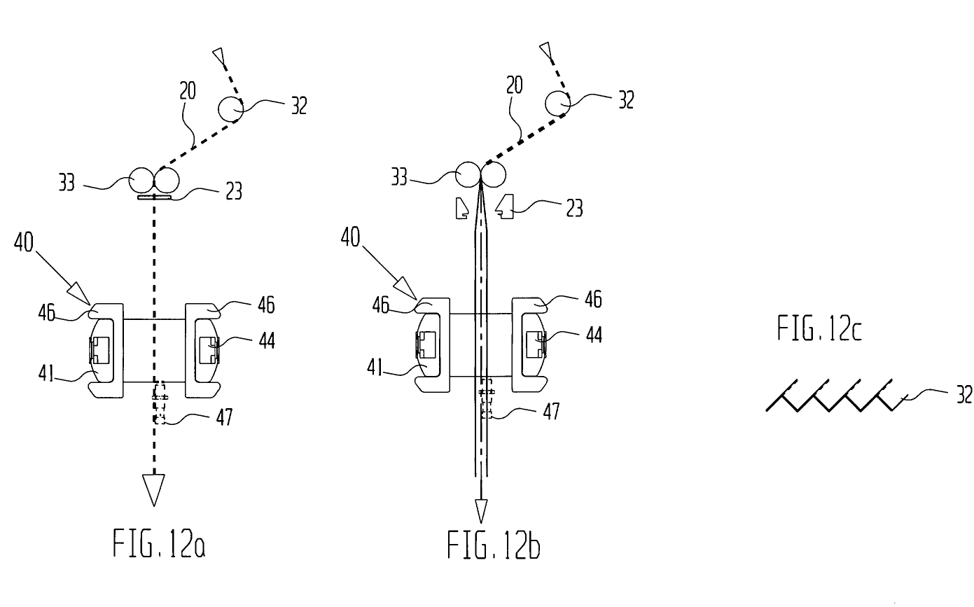

FIGS. 12a and 12b show an alternate mode of loading web material 20 onto a wind-up spindle 40. In these cases the web 20 is oriented to pass vertically down between forks 41 under the action of drive 33. Thereafter spindle 40 is spun to wind up web 20. All other operations being handled in a similar way as described with regard to FIGS. 4 and 9.

In the embodiment of FIG. 12b the web material 20 is shaped by drive rollers 33 by applying fold lines to web 20 to give the material more structural rigidity than if left flat as shown in FIG. 12a. This stiffening of the web 20 by applying folds or ribs enables web 20 to traverse a greater distance without being easily diverted from its path of travel than if it were a planar sheet.

FIG. 12c is an isometric view of a portion of ribbed or folded web material as employed in the embodiment of FIG. 12b.

It will be appreciated by persons skilled in the art that numerous variations and/or modifications may be made to the inventions as shown in the specific embodiments without departing from the spirit or scope of the inventions as broadly described. The present embodiments are, therefore, to be considered in all respects as illustrative and not restrictive.

1. A method of butt joining webs by splicing a trailing edge of a first web to leading edge of a second web and subsequent splicing of a trailing edge of the second web to a leading edge of a replacement first web, said method including supplying the first web from a first web supply station and the second web from a second web supplying station, said first web passing a first splicing station and the second web passing a second splicing station spaced apart from the first splicing station, drawing the first web from the first web supplying station while the leading edge of the second web is fixedly positioned at a first to predetermined location at the second splicing station ready to be spliced to the trailing edge of the first web; detecting and holding the trailing edge of the first web at a second predetermined location on carriage means, moving carriage means holding the trailing edge of the first web to the second splicing station so that the leading edge of the second web and the trailing edge of the first web are in an abutting relation, and splicing the trailing edge of the first web to the leading edge of the second web via a splice applied across one face of a junction between the first and second webs; whereafter a replacement first web is fitted to the first web supplying station and a leading edge of the replacement first web is positioned at the first splicing station ready to be spliced to the trailing edge of the second web, upon detecting, holding and moving the carriage means holding the trailing edge of the second web from adjacent the second splicing station to the first splicing station, and applying a splice across the one face of a junction between the trailing edge of the second web and the leading edge of the replacement first web.

2. A method as claimed in claim 1 wherein the web material is supplied to a work station downstream of the splicing stations.

3. A method as claimed in claim 2 wherein each web supports a plurality of self-adhesive labels adapted to be removed from each web and applied to articles downstream of the splicing stations at said work station.

4. A method as claimed in claim 2 wherein feeding of web material to the work station downstream of the splicing stations is continued during each splicing operation via an oversupply of web material maintained between the splicing stations and the work station and wherein the oversupply of web material is at least partially consumed during each splicing operation.

5. A method as claimed in claim 1 wherein securing of each splice is effected by means of pressure sensitive adhesive interposed between the trailing edge of one web and the leading edge of the other web.

6. A method as claimed in claim 1 where the two splicing stations are in parallel and spaced apart in a vertical plane.

7. An apparatus for splicing a trailing edge of one web to a leading edge of another web, said apparatus including two web supplying stations, one web supply adapted to feed a first web to a first splicing station and the other web supply being adapted to feed a second web to a spaced apart second splicing station, and wherein each splicing station includes hold down means for holding a leading edge of a respective web against a splicing table, carriage means movable between each splicing station for carrying a trailing end of the first web from the first splicing station to the second splicing station and for carrying a trailing end of the second web from the second splicing station to the first splicing station, said carriage means including means for placing the trailing end of one web in abutting register with the leading end of the other web and means for effecting a splice between the trailing and leading ends in register.

8. An apparatus as claimed in claim 7 including means downstream of the splicing stations for maintaining an oversupply of web material between the splicing stations and a work station to enable consumption of web material via a downstream process applied to the web at the work station during each splicing operation.

9. An apparatus as claimed in claim 7 wherein the splicing stations are oriented in parallel spaced apart relation in a vertical plane.

10. An apparatus as claimed in claim 7 wherein the carriage means moves between home positions against the first and second splicing tables via a movement in alignment with and away from a home position relative to one table then to a position in alignment with the other table followed by movement to a home position relative to the other table.

11. An apparatus as claimed in claim 7 wherein each web includes an adhesive surface facing inwardly of the web at a leading end which is adapted to adhere to the trailing end of another web under the action of effecting the splice which includes means for pressing the trailing and leading ends of respective webs together.

12. A method of forming and removing a roll of web material from a rotatable device, said method comprising loading a quantity of web material onto the rotatable device, clamping and cutting the web being wound onto the rotatable device when a predetermined quantity of web material has been wound onto the rotatable device, pushing the wound web off the rotatable device, reattaching the cut end of the web to the rotatable device and winding a next quantity of web onto the rotatable device.

13. A method as claimed in claim 12 including providing an oversupply of web material upstream of the rotatable device for storing web material while clamping, cutting and pushing the predetermined quantity of wound web off the rotatable device is carried out.

14. A splicing tape comprising a reel of adhesive tape said adhesive tape having an adhesive surface fitted with release paper separable longitudinally of the adhesive tape.

15. A splicing tape as claimed in claim 14 wherein one of the release papers overlays the other release paper as well as part of the adhesive surface.

16. A method for affixing a web of material to a hub of an unwinding reel, said method comprising applying a double-sided adhesive tape to the hub of the reel, said tape having adhesives of differing strengths on opposite sides and wherein the side with the higher adhesive strength is applied to the hub, the adhesive side of the tape facing outwardly of the hub being adapted to grip and hold the end of a web wound onto the hub such that upon unwinding of the web, the end of the web separates from the adhesive tape and the adhesive tape remains adhered to the hub.
